(19) United States
(12) Patent Application Publication
(10) Pub. No.: US 2011/0251530 A1
(43) Pub. Date: Oct. 13, 2011

(54) PRESSURE WAVE TREATMENT EQUIPMENT EQUIPPED WITH A SYSTEM FOR MOVING THE CURVED SECTION OF AN X-RAY IMAGING SYSTEM

(75) Inventors: Pierre REBOUL, Dardilly (FR); Olivier NALLET, Lyon (FR); Andre PEYRARD, Saint Christo en Jarez (FR)

(73) Assignee: EDAP TMS FRANCE, Vaulx-en-Velin (FR)

(21) Appl. No.: 13/084,094

(22) Filed: Apr. 11, 2011

(30) Foreign Application Priority Data
Apr. 13, 2010 (FR) 10 52791

(51) Int. Cl. A61H 1/00

(52) U.S. Cl. 601/4

(57) ABSTRACT

Processing equipment by pressure waves includes a chassis supporting a pressure-wave generator. According to the invention, the processing equipment includes an actuation system including a fixed part mounted on the chassis and a mobile part in translation according to a direction substantially perpendicular to an axis of oscillation of a curved section of an imaging system, a linking system with the curved section, connected to the mobile part in translation of the actuation system, and a control unit of the actuation system for placing the linking system in at least two stable positions corresponding to two different positions of incidence of the curved section of the imaging system.

### BACKGROUND OF THE INVENTION

The present invention relates to apparatus for destruction of solid intracorporeal concretions for lithotrity treatments.

As is known, lithotrity apparatus comprises a pressure-wave generator such as acoustic shockwaves used to destroy concretions or renal, biliary or salivary lithiases. Lithotrity equipment is linked to an imaging device for detecting and displaying the presence of lithiases in the body of a patient or animal. The lithiases and the core of the generator coincide by way of mechanical shift systems used to guide either the lithiases to the focal point of the generator or guide the focal point of the generator to the lithiases.

An imaging system for displaying the lithiasis and determining its positioning in three dimensions should be used to execute this correspondence. Ultrasound X-ray imaging systems are the imaging devices most in current use.

An ultrasound imaging device produces an image plane in two dimensions in the form of an anatomical section whereof the orientation is determined by the operator handling an echographic probe. When this sectional plane displays the lithiasis it is possible to determine the position of the latter in space subject to knowing the position and orientation of the echographic probe as well as the position of the lithiasis in the echographic image plane.

Spatial location of a lithiasis is substantially more complex to carry out from an X-ray imaging system of the curved section type such as that described by documents EP 0 715 831, DE 103 03 462 or EP 0 397 980. An X-ray imaging system comprises a curved section equipped at one of its ends with an X-ray source and at the other of its ends and vis-à-vis with an imaging sensor. This curved section is mounted mobile in rotation about an axis of oscillation perpendicularly cutting the axis passing through the X-ray source and the imaging sensor. This type of imaging system utilises a two-dimensional image resulting from anatomical projection of the biological structures on the plane of the imaging sensor. In contrast to the ultrasound imaging system, this two-dimensional image does not contain the spatial information necessary for localisation in space of the lithiasis even precisely knowing the position of the curved section. To use this spatial information, it is necessary to take a second image with incidence different to the curved section relative to the lithiasis, for example by a few tens of degrees, relative to the incidence of the curved section taken during the first image. The two images taken represent the lithiasis according to two different projections. In identifying the lithiasis on each of these two images it is possible to determine the position in space of the lithiasis using known calculation methods or successive alignment methods.

Of course, the production of these two frames must be done consecutively such that the spatial position of the lithiasis is not modified between the two frames that is, the patient has remained immobile. In practice, the operator must position the curved section in a first position, take a first frame then change the incidence of the curved section to place it in a second position of incidence to take the second frame.

It should be noted that the operator cannot remain near the X-ray source when it is emitting rays for taking frames. Also, for each of the frames, the operator must be shielded behind a protective screen, then return to the equipment to modify the incidence of the curved section and again step back to be protected from the emission resulting from this frame. In practice, taking two frames is a relatively long procedure, to the point where the patient has frequently moved between the two frames such that it seems necessary to start the image-taking procedure over again.

In an attempt to resolve this problem the prior art has proposed an X-ray imaging system whereof the curved section is motorised to prevent intervention by an operator for modifying incidence of the curved section between taking two images. Such an X-ray imaging system proves very costly and in practical terms does not seem adapted to be linked to lithotrity equipment. In fact, the motorisation control of the curved section is generally situated on the frame of the imaging system, making it seem difficult for the operator to control both the imaging system and the lithotrity equipment.

### SUMMARY OF THE INVENTION

The present invention thus aims to rectify the drawbacks of the prior art by proposing a solution for placing the curved section of an X-ray imaging system in two stable positions, automatically, simply and smoothly, when such an imaging system is used in association with lithotrity equipment.

Another subject matter of the invention is to propose a solution for motorisation of the curved section of an X-ray imaging system for using this imaging system independently of the lithotrity equipment.

To attain such aims, the subject matter of the invention relates to processing equipment by pressure waves comprising a chassis supporting a pressure-wave generator.

According to the invention, the processing equipment comprises:
an actuation system comprising a fixed part mounted on the chassis and a mobile part in translation according to a direction substantially perpendicular to an axis of oscillation of a curved section of an independent imaging system relative to the processing equipment,
a linking system with the curved section, comprising a assembly structure disassemblable between the curved section and the mobile part in translation of the actuation system,
and a control unit of the actuation system for placing the linking system in at least two stable positions corresponding to two different positions of incidence of the curved section of the imaging system.

Also, the processing equipment according to the invention can have a combination of at least one and/or the other of the following additional characteristics:
a control device of the course of the mobile part of the actuation system, this control device being connected to the control unit,
the disassemblable assembly structure comprises a clamp fitted with pressure screws,
the linking system with the curved section is connected to the mobile part of the actuation system by means of an articulated structure,
the articulated structure comprises an axis of articulation substantially horizontal and substantially parallel to the axis of oscillation of the curved section and a substantially vertical axis of articulation allowing vertical and/or horizontal rotation of the mobile part of the actuation system relative to the assembly structure,
the fixed part of the actuation system is mounted on the chassis by means of an articulation structure,
the articulation structure comprises a substantially horizontal axis of articulation and a substantially vertical axis of articulation allowing vertical and/or horizontal rotation of the fixed part of the actuation system relative to the chassis,
the actuation system is mounted on the chassis such that the direction of translation of the mobile part is away from the axis of oscillation of the curved section,
the actuation system is mounted on the chassis to extend below the pressure-wave generator,
the chassis is provided with protective walls whereof at least one comprises a passage opening for the mobile member of the actuation system.

The processing equipment according to the invention linked to an imaging system of the type with curved section forms medical equipment for treatment of lithiases by pressure waves.

The equipment accordingly comprises:
an imaging system comprising a curved section mounted oscillating according to an axis of oscillation,
and independent processing equipment by pressure waves relative to the imaging system and comprising especially a linking system with the curved section comprising a disassemblable assembly structure between the curved section and a mobile part in translation of an actuation system forming part of the processing equipment.

### BRIEF DESCRIPTION OF THE DRAWINGS

Various others characteristics will emerge from the following description in reference to the attached diagrams which show, by way of non-limiting examples, embodiments of the subject matter of the invention.

FIG. 1 is a perspective view showing processing equipment by pressure waves according to the invention.

FIGS. 2A and 2B are views illustrating the processing equipment in two positions characteristic of positioning of the curved section of an imaging system.

FIGS. 3 and 4 are detailed views respectively from the front and side of the link between the curved section of the imaging system and the processing equipment.

FIG. 5 is a detailed view showing fixing of the actuation system to the chassis of the processing equipment.

### DESCRIPTION OF THE PREFERRED EMBODIMENTS

As is evident more precisely from the figures, the subject matter of the invention relates to processing equipment 1 by pressure waves, of concretions or intracorporeal lithiases localised in the body of a patient or animal using an imaging system 2 of X-ray type.

An imaging system 2 X-ray conventionally comprises a semi-circular curved section 3 equipped at one end with an X-ray source 4 and at its other end with an imaging sensor 5. In the example illustrated, the curved section 3 has a planar principal face 3₁ of incurved profile bordered on either side by lateral faces 3₂. The X-ray source 4 and the imaging sensor 5 are situated vis-à-vis one another according to a general direction X by being moved away to allow positioning of a patient. The curved section 3 is mounted mobile in rotation relative to a chassis 6 according to an axis of oscillation 7 extending according to a horizontal direction Y. The axis of oscillation 7 is situated in the middle of the curved section 3 such that the horizontal direction Y of the axis of oscillation 7 perpendicularly cuts the common direction X of extension of the X-ray source 4 and of the imaging sensor 5.

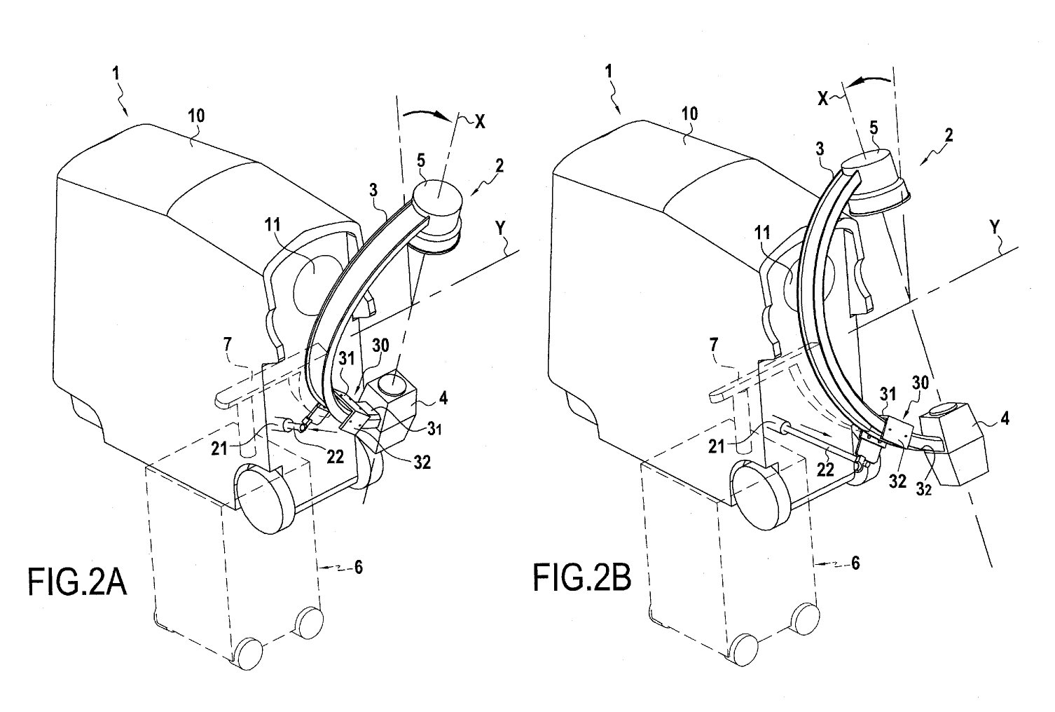

As is evident more precisely from FIGS. 2A and 2B, the curved section 3 can thus occupy two different stable positions of incidence in each of which a frame can be taken of a person positioned between the X-ray source 4 and the imaging sensor 5. For example, the incidence offset between the two positions illustrated in FIGS. 2A and 2B which is obtained by rotation of the curved section 3 about the axis of oscillation 7 is of the order of a few tens of degrees. The imaging system 2 is not described in greater detail as it is well known to the expert and does not form part of the subject matter of the invention.

The processing equipment 1 according to the invention such as lithotrity equipment comprises a frame or a chassis 10 equipped with a pressure-wave generator 11, such as acoustic shockwaves. In the embodiment illustrated, the chassis 10 has a substantially parallelepipedic form and is advantageously enveloped by a cowling or protective walls. For example, the chassis 10 is equipped with two side walls 10₁ extending substantially parallel to each other and joined together on one side by a rear wall 10₂ and on the other side by a front wall 10₃. The side walls 10₁ and the front 10₃ and rear 10₂ walls are joined together at their upper part by a top wall 10₄. The chassis 10 is conventionally equipped with wheels 13 for rolling and shifting the chassis 10.

The generator 11 is conventionally adapted to emit acoustic shockwaves directed to a target for coincidence by means of the imaging system 2, with the concretions in light of destroying the latter. The generator 11 conventionally comprises an ellipsoidal reflector in which is positioned an electrode for generating an acoustic shockwave au first focal point of the ellipsoidal reflector. Due to the particular geometry of the reflector, the shockwave created at the first focal point is now reflected to the second focal point of the reflector, the second focal point being outside the generator, allowing targeting of concretions situated in the body of a patient or animal. The generator 11 is not described in greater detail here since it is not really part of the invention and its production is well known to the expert.

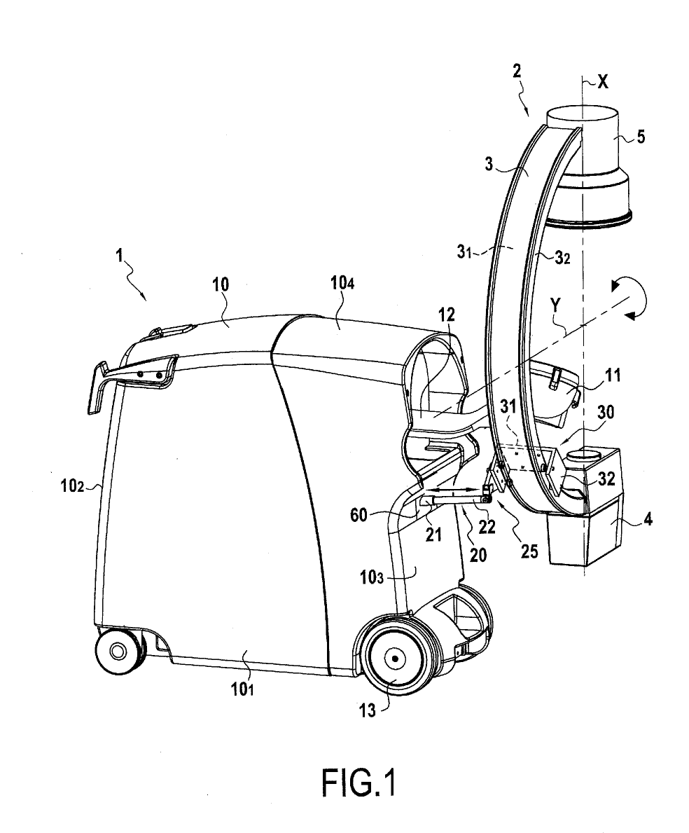

In the example illustrated, the generator 11 is mounted on a guide structure 12 for moving it between a retracted position inside the chassis 10 (FIG. 2A, 2B) and an extended or treatment position (FIG. 1) in which the generator 11 is located near the patient. Of course, the generator 11 can be mounted in a different way on the chassis 10 by being shifted or not relative to the chassis 10.

In keeping with the invention, the processing equipment 1 comprises an actuation system 20 for the curved section 3 of the imaging system 2 (FIG. 1). The actuation system 20 acts on the curved section 3 to ensure its rotation about the axis of oscillation 7 to produce positioning of the curved section 3 in two stable positions having different incidences (FIG. 2A, 2B). The actuation system 20 comprises a fixed part 21 mounted on the chassis 10 and a mobile part in translation 22 according to a direction substantially perpendicular to the axis of oscillation 7. The actuation system 20 exerts a thrust or traction force substantially perpendicular to the axis of oscillation 7. The point of application of this thrust or traction force on the curved section 3 is naturally offset relative to the axis of oscillation 7 to engender rotation of the curved section 3 about the axis of oscillation 7.

According to a preferred variant embodiment, the actuation system 20 comprises a jack whereof the body 21 is fixed on the chassis while the rod 22 is shifted in translation to enable oscillation of the curved section 3. The jack 20 can be any kind, for example electric, pneumatic or hydraulic. Of course, the actuation system 20 can be made in a different way, such as for example by an actuator with linear movement integrating or not a movement transformation system.

The processing equipment 1 as illustrated in FIG. 1, also comprises a linking system 25 with the curved section 3 connected to the mobile part 22 of the actuation system 20. This system 25 ensures linking or disassemblable or temporary assembly between the actuation system 20 and the curved section for placing the latter in at least two stable positions corresponding to two different positions of incidence of the curved section 3. The processing equipment 1 and the imaging system 2 are designed to be independent of each other or to be fully separate such that the imaging system 2 may be used while the processing equipment 1 is separate from the imaging system. When there is a need, the linking system 25 ensures temporary disassemblable assembly between the curved section 3 of the imaging system 2 and the processing equipment 1.

According to a variant embodiment, the linking system 25 comprises an assembly structure 30 disassemblable between the curved section 3 and the mobile part 22 of the actuation system

(FIG. 2A, FIG. 2B). In the embodiment illustrated, the disassemblable assembly structure 30 is in the form of a clamp comprising a central core 31 prolonged on either side and at an angle by two wings 32. The clamp 30 is mounted to overlap or fit onto the curved section 3 such that the wings 32 extend on either side of the lateral faces 3₂ of the curved section whereas the core 31 covers the principal face 3₁. The clamp 30 is fixed on the curved section 3 by means of pressure screws 35 borne by the wings 32 (FIG. 4). The clamp 30 can easily be connected or disconnected relative to the curved section 3 respectively by tightening and loosening of the pressure screws 35. In other terms, the imaging system 2 can easily be made independent relative to the processing equipment 1 to the extent where the linking system 25 is connected to the mobile part 22 by way of an assembly structure of disassemblable capacity. It should be noted that the conception of the assembly structure 30 (clamp and pressure screw) can be adapted, without modification, to all types of curved sections 3.

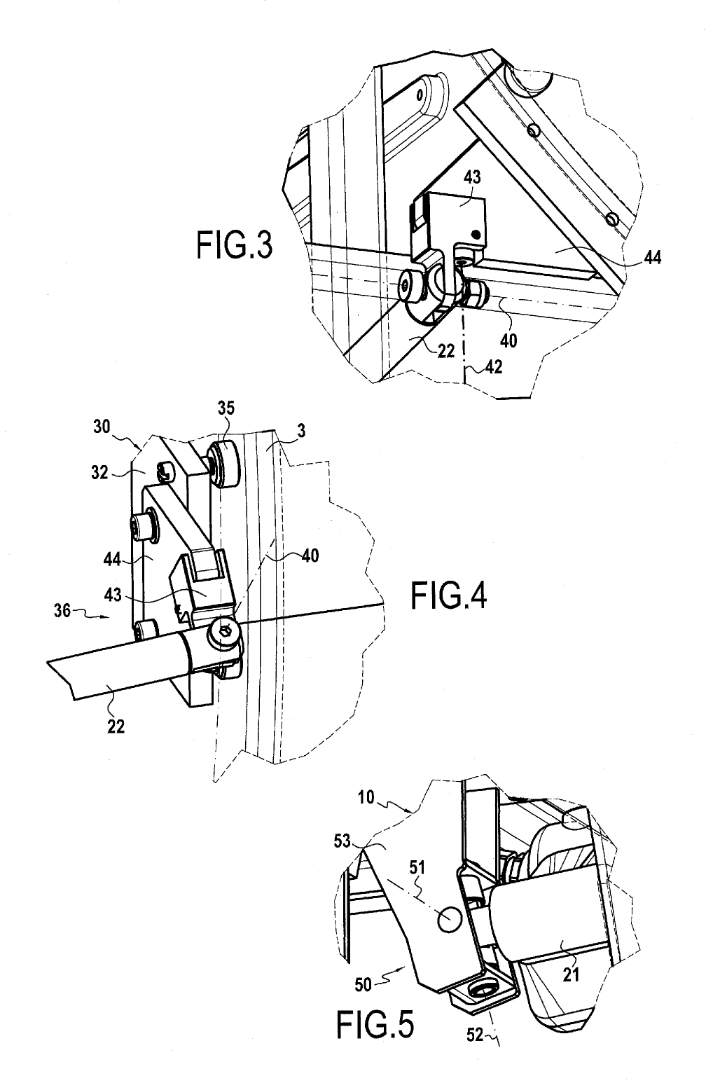

According to a preferred variant embodiment, the linking system 25 comprises between the curved section 3 and the mobile part 22 of the actuation system 20 an articulated structure 36 adapted to ensure rotation of the curved section 3 when the latter is subjected to linear shift force perpendicular to the axis of oscillation 7. As is more evident from the example illustrated in FIGS. 3 and 4, the articulated structure 36 is interposed between the mobile part 22 of the actuation system 20 and the clamp 30. This articulated structure 36 comprises an axis of articulation 40 substantially horizontal and substantially parallel to the axis of oscillation 7 of the curved section and n substantially vertical axis of articulation 42 allowing in combination, vertical and/or horizontal rotation of the mobile part 22 of the actuation system 20 relative to the clamp 30. In the example illustrated, the horizontal axis of articulation 40 is mounted between the end of the mobile part 22 and an intermediate linking piece 43 capable of pivoting about this horizontal axis of articulation 40. The vertical axis of articulation 42 is mounted between the intermediate linking piece 43 and a flange 44 fixed to a wing 32 of the clamp 30.

Advantageously, the intermediate linking piece 43 is mounted by way of disassemblable assembly (preferably without tools) relative to the flange 44, enabling the operation for placing and removing the clamp 30. Also, the linking system 25 can be detached from the actuation system 20, enabling folding of the rod 22 of the jack.

The jack 20 is preferably mounted in a retracted position of the rod, and the jack 20 is fully stowed inside the chassis 10.

According to a preferred variant embodiment, the fixed part 21 of the actuation system 20 is mounted on the chassis 10 by means of an articulation structure 50. For example, the articulation structure 50 comprises a substantially horizontal axis of articulation 51 and a substantially vertical axis of articulation 52 allowing joint vertical and/or horizontal rotation of the fixed part 21 of the actuation system 20 relative to the chassis 10. In the example illustrated in FIG. 5, the horizontal axis of articulation 51 is mounted between the body 21 of the jack and the two branches of a clamp 53 presented by the chassis 10. The vertical axis of articulation 52 is mounted between the body 21 of the jack and the clamp 53. These two degrees of liberty of rotation of the jack 20 relative to the chassis 10 are utilised during the shift operation of the curved section 3.

The processing equipment 1 also comprises a unit, not shown, of the actuation system 20 for placing the linking system 25 in at least two stable positions corresponding to two different positions of incidence of the curved section 3. For example, this control unit pilots the actuation system 20 by sending electric control signals. Advantageously, this control unit forms part of the control and management electronics of the processing equipment 1. In this way, orders given for moving and stopping the actuation system 20 can be controlled from the control and management electronics of the processing equipment 1.

According to a preferred variant embodiment, this control unit is connected to a control device of the course of the mobile part 22 of the actuation system 20. Such a control device is designed to inform the operator of the course of the mobile part 22 or of potential collision risks with equipment located in the environment and/or interrupt movement of the actuation system 20. The control device comprises especially motion sensors, force sensors and/or proximity sensors.

According to a preferred variant embodiment, the actuation system 20 is mounted on the chassis 10 such that the direction of translation of the mobile part 22 is away from the axis of oscillation 7 of the curved section 3 to minimise forces to be applied to the curved section 3. In other terms, the actuation system 20 is mounted such that the point of application of the thrust or traction force exerted by the actuation system 20 is the farthest possible from the axis of oscillation 7 to minimise forces to be exerted in view of procuring the preferred oscillation for the curved section 3. The point of application can be located above or below the axis of oscillation 7 located in the centre of the curved section 3.

In the preferred example illustrated in the diagrams, the actuation system 20 is mounted on the chassis 10 such that the point of application of force is located below the axis of oscillation 7. According to this preferred though non-exclusive variant, the actuation system 20 is mounted on the chassis 10 to extend below the generator 11. So, the generator 11 and the mobile part 22 are located above one another, at the level of the front wall 10₃. This front wall 10₃ comprises a passage opening 60 for the mobile member 22 of the actuation system 20.

It is evident from the preceding description that the processing equipment 1 ensures its conventional functions of treating lithiases and controlling rotation of the curved section 3 of an imaging system 2 to place it automatically in two characteristic positions for taking images. The processing equipment 1 and the system for taking images 2 together form equipment adapted for treating lithiases by pressure waves. Given the removable assembly between the processing equipment 1 and the imaging system 2, the latter can be used independently of lithotrity equipment. Also, given the removable assembly between the linking system 25 and the actuation system 20, the latter can be mounted to be fully retracted inside the chassis 10 when the rotation control of the curved section of an imaging system 2 is not required.

The invention is not limited to the examples as described and illustrated as diverse modifications can be made without departing from its scope.

What is claimed is:

1- Treatment equipment by pressure waves comprising a chassis (10) supporting a pressure-wave generator (11), comprising:
an actuation system (20) comprising a fixed part (21) mounted on the chassis (10) and a mobile part in translation (22) according to a direction substantially perpendicular to an axis of oscillation (7) of a curved section (3) of an independent imaging system (2) relative to the processing equipment.
a linking system (25) with the curved section (3), comprising a disassemblable assembly structure (35) between the curved section (3) and the mobile part in translation (22) of the actuation system (20), and
a control unit of the actuation system (20) for placing the linking system (25) in at least two stable positions corresponding to two different positions of incidence of the curved section (3) of the imaging system.

2- The treatment equipment as claimed in claim 1, comprising a control device of the course of the mobile part (22) of the actuation system (20), this control device being connected to the control unit.

3- The treatment equipment as claimed in claim 1, wherein the disassemblable assembly structure comprises a clamp (30) fitted with a pressure screw (35).

4- The treatment equipment as claimed in claim 1, wherein the linking system (25) with the curved section (3) is connected to the mobile part (22) of the actuation system (20) by means of an articulated structure (36).

5- The treatment equipment as claimed in claim 4, wherein the articulated structure (36) comprises an axis of articulation (40) substantially horizontal and substantially parallel to the axis of oscillation (7) of the curved section and a substantially vertical axis of articulation (42) allowing vertical and/or horizontal rotation of the mobile part (22) of the actuation system (20) relative to the assembly structure (30, 35).

6- The treatment equipment as claimed in claim 1, wherein the fixed part (21) of the actuation system (20) is mounted on the chassis by means of an articulation structure (50).

7- The treatment equipment as claimed in claim 6, wherein the articulation structure (50) comprises a substantially horizontal axis of articulation (51) and a substantially vertical axis of articulation (52) allowing vertical and/or horizontal rotation of the fixed part (21) of the actuation system relative to the chassis (10).

8- The treatment equipment as claimed in claim 1, wherein the actuation system (20) is mounted on the chassis (10) such that the direction of translation of the mobile part (22) is away from the axis of oscillation (7) of the curved section.

9- The treatment equipment as claimed in claim 1, wherein the actuation system (20) is mounted on the chassis to extend below the pressure-wave generator (11).

10- The treatment equipment as claimed in claim 1, wherein the chassis (10) is provided with protective walls whereof at least one (10₃) comprises a passage opening (60) for the mobile member (22) of the actuation system (20).

11- The treatment equipment as claimed in claim 1, wherein the actuation system (20) comprises a jack.

12- Equipment for executing treatment by pressure waves, comprising:
an imaging system (2) comprising a curved section (3) mounted oscillating according to an axis of oscillation (7),
and processing equipment (1) by pressure waves as claimed in any one of claims 1 to 11, independent relative to the imaging system (2) and comprising especially a linking system (25) with the curved section (3) comprising an assembly structure disassemblable (35) between the curved section (3) and a mobile part in translation (22) of an actuation system (20) forming part of the processing equipment (1).
